(19) United States
(12) Patent Application Publication
(10) Pub. No.: US 2018/0113569 A1
(43) Pub. Date: Apr. 26, 2018

(54) ELECTRONIC BRACELET FOR DISPLAYING AN INTERACTIVE DIGITAL CONTENT DESIGNED TO BE PROJECTED ON A ZONE OF AN ARM

(71) Applicant: CN2P, La Défense Cedex (FR)

(72) Inventors: Pascal POMMIER, Paris (FR); Guillaume POMMIER, Paris (FR); Nicolas CRUCHON, Ailly Sur Noye (FR); Fabien VIAUT-NOBLET, Paris (FR)

(21) Appl. No.: 15/565,341

(22) PCT Filed: Apr. 8, 2016
(86) PCT No.: PCT/EP2016/057848

§ 371 Date: Nov. 1, 2017

(30) Foreign Application Priority Data
Apr. 10, 2015 (FR) 1553161

(51) Int. Cl. G06F 3/042; G06F 1/16; H04N 9/31; G06F 3/041

(52) U.S. Cl. CPC G06F 3/0425; G06F 1/163; G06F 1/1639; G06F 3/0418; H04N 9/3185; H04N 9/3194; G06F 1/169

(57) ABSTRACT

An electronic bracelet for displaying an interactive digital content to be projected onto a zone of an arm, includes an emitter of a light beam in a non-visible frequency band forming a light sheet designed to cover a first zone of an arm; a projector projecting an image over a second zone, the first zone substantially overlapping with the second zone; a first detector acquiring an image of the second zone; a computer determining at least one position of at least one interaction point of the light beam by analysing a trace of the image acquired by the first detector.

### FIELD

The field of this invention relates to electronic bracelets for displaying a digital content on a part of an arm.

### PRIOR ART

Currently, there is an electronic bracelet able to project images. This solution is presented in the patent application US2015/0054730. However, the detection mode for the interactions with images has disadvantages. Indeed, false detections can occur due to the poor appreciation of the position of a finger. Moreover, such a solution meets difficulties of implementation both for the detection accuracy on the interaction zones and for the projection quality provided over a relatively small zone.

There is a need for a robust projector of images, in-built in a bracelet, having good image definition and providing reliable interactivity notably relating to the detection of points of interest, that a user wants to activate.

### SUMMARY OF THE INVENTION

The invention aims at remedying the pre-cited disadvantages.

The object of the invention relates to an electronic bracelet for displaying an interactive digital content designed to be projected on a zone of an arm. The bracelet comprises:
An emitter of a light beam in a non-visible frequency band forming a light sheet designed to cover a first arm zone;
A projector projecting an image over a second zone, the first zone substantially overlapping with the second zone;
A first detector capturing an image of the second zone;
A computer determining at least one position of at least one interaction point of the light beam by analysing a trace of the image acquired by the first detector.

One advantage is that of providing a projection alternative for a touch-screen. The display device takes up little space and is easy to transport, reducing the possibility of mislaying or losing the bracelet.

According to one embodiment, the bracelet comprises a band designed to be held around a wrist, a power supply source and a frame arranged and held on an upper part of the bracelet, said frame comprising the emitter, the projector, the first detector and the computer.

One advantage is that of distributing the bracelet weight so as to find a balance. Another advantage is that of making the power supply removable without any impact of the bracelet frame.

According to one embodiment, the bracelet comprises:
A component for applying factors of distortion to the projected image, in order to compensate for:
   a surface distortion relating to the anatomy of the forearm, and/or;
   a distortion of perspective taking into account:
      lateral distortions of the projected image;
      distortions of field depth of the projected image;

One advantage is that of making possible a comfortable display in a substantially rectangular format or at least giving the perception that the image is substantially perpendicular. One advantage is that of compensating for the surface effects relating to the anatomy of the forearm, such as the lateral curvature of the forearm which could distort the image. It is also possible to compensate for the effects of perspective.

According to one embodiment, the distortion factors are transformation factors of a first 2D geometrical shape into a second 2D geometrical shape.

According to one embodiment, the light beam emitter is an infra-red emitter. One advantage is that it is invisible to the user.

According to one embodiment, the emitter is a linear emitter projecting a substantially flat light beam.

According to one embodiment, the emitter is an emitter arranged on the frame in a position located in-between the projector and the bracelet band. One advantage is that of benefiting from the difference in height between the infra-red projector and the detector so as to optimise the resolution and the accuracy of capturing an image, and thus from the position of the center of the interaction.

According to one embodiment, the first detector comprises a sensitivity range making it possible to detect a trace caused by the interception of the light beam with a body. The sensitivity range is suitable for infra-red range. When the detector range is wider, filters can be applied. When the trace appears over adjoining ranges or ranges close to infra-red range, a detector sensitive to this frequency range can be used.

According to one embodiment, the first detector is an infra-red detector capturing an image in which the light beam forms an image, of which the longitudinal dimensions can be identified that is to say along the projection direction.

According to one embodiment, the position of at least one interaction point is calculated from:
a transformation of the image and of the trace, both acquired in an original image comprising an image of the trace from transformation factors.
a geometrical construction of an interaction point of at least one trace or image of the trace.

According to one embodiment, the computer compares the position of the interaction point with a matrix of points delimiting interaction zones in a frame of reference linked to the original image, the computer inferring an interaction probability with the interaction zone.

According to one embodiment, the bracelet further comprises a second detector acquiring colorimetric images of the second zone.

According to one embodiment, the bracelet comprises an image stabiliser, said image stabiliser comparing the images acquired by the second detector with the dimensions of a reference image, and generating corrective factors to apply to the image distortion factors depending upon the comparison between images.

According to one embodiment, the image stabiliser compares the longitudinal dimensions of the second zone of the images acquired by the first detector with the dimensions of the images acquired by the second detector to generate corrective factors to apply to the transformation factors.

According to one embodiment, the computer generates a control image and the projector regularly projects said control image into the projected image flow, said control image being acquired by at least one detector of the bracelet so as to compare characteristic dimensions of the acquired image with a reference image, to calculate factors for correcting images.

According to one embodiment, the reference image is calculated during a calibration or first-use operation, the reference image being obtained by applying transformation factors to a projected image to obtain a displayed image with the desired dimensions, that is to say having a substantially rectangular shape, the application of transformation factors during this operation being carried out from an interface of the bracelet.

According to one embodiment, the second detector performs a second calculation of an interaction point via the analysis of a trace intercepting the image, said trace being obtained via an analysis of the modification of pixel colour in a portion of the acquired image.

According to one embodiment, the computer comprises a pattern recognition function making it possible to detect the shape of a finger in the image, and to determine an end point thereof to infer an interaction point.

According to one embodiment, a computer correlates the position of an interaction point obtained from an image acquired by the first detector and the position of an interaction point obtained from an image acquired by the second detector, the correlation of positions making it possible to generate a new position of an interaction point.

According to one embodiment, the image projector is a colour pico-projector.

According to one embodiment, the image projector comprises a blue laser, a red laser and a green laser, and a set of micro-mirrors rotating so as to produce, at each projection point, a point the colour of which is generated by a combination of the three lasers oriented by mirrors.

According to one embodiment, the image projector can be an LCOS projector.

According to one embodiment, the image projector emits an image with a 1920×2080 resolution.

According to one embodiment, the bracelet comprises an accelerometer and a gyroscope making it possible to activate functions generating a modification or a change of the image projected by the projector.

According to one embodiment, the power supply is a removable battery.

Another object of the invention relates to a projection device comprising the bracelet of the invention, and comprising a base comprising means of holding the bracelet, the calculator of the bracelet, which comprises a second projection mode, comprises second image distortion factors making it possible to project images onto the second projection plane, the second projection plan being merged with the support plane of the base.

According to one embodiment, the base comprises a substantially flat emitter of an infra-red beam, and a detector, both placed on the face opposite the support, and facing the image projection from the projector, said detector recording images comprising at least one trace of interaction when the beam is intercepted by a body, the computer generating interaction instructions which modify the projected image depending upon a detected interaction zone.

### SHORT DESCRIPTION OF FIGURES

Other characteristics and advantages of the invention will be clear from the detailed description which follows, in reference to the figures appended, which illustrate:

FIG. 1: a front view of an electronic bracelet comprising a projector from the invention;

FIG. 2: a user arm wearing a bracelet from the invention;

FIG. 3: a lateral section view of the bracelet from the invention, and a projection mode for an image;

FIG. 4: a representation of a gridding used for detecting an interaction point on a projected image;

FIG. 5: a superposition of an original image and of a matrix of delimiting points for the calculation of an interaction zone;

FIG. 6: an electronic bracelet positioned on a base so as to provide a second display mode;

FIGS. 7A to 7E: an example of applications of transformation factors calculated from the acquisition of a projected image;

FIG. 8: an example of detection of an interaction point from the analysis of images captured by the colorimetric detector and the infra-red detector.

### DESCRIPTION

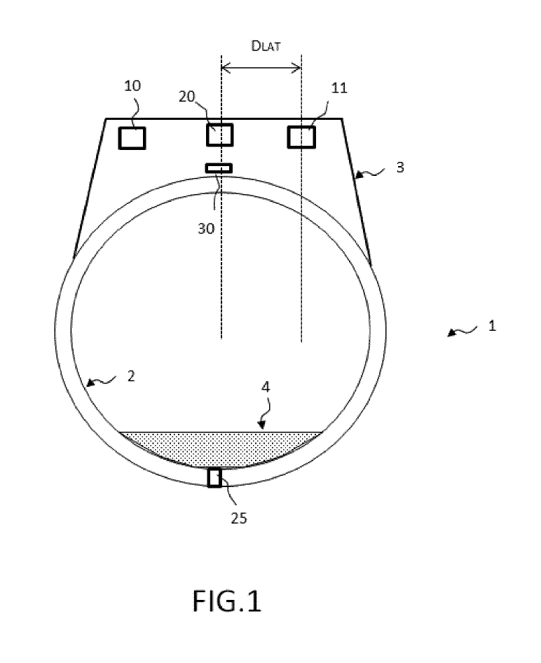

FIG. 1 shows an embodiment of a bracelet 1 from the invention. The bracelet comprises a frame 3, a band 2 and a power supply 4.

Band

The band 2 forms the part of the bracelet making it possible to keep said bracelet around the wrist of a person. It can comprise a means of adjustment 25 of the fastening position of the band so as to adapt to different wrist circumferences. The means of adjustment 25 of the position of the bracelet 1 can also make it possible to attach to each other, two parts of the band around the wrist. The band can be of flexible elastic material, of textile or of rigid material such as a rigid plastic material, of metal or of foam or of any other material making it possible to form a band. The band 2 can comprise a thin thickness of the size of a watch bracelet of a few millimetres, or instead be thicker, of the order of 1 or 2 cm.

The lower part of the bracelet 1 is designated as a part opposite to the part of bracelet 1 which comprises the frame 3 corresponding to the upper part of the bracelet 1.

Power Supply Source

According to one embodiment, a power supply source 4 is positioned at the lower part of the bracelet 1, so as to make the frame 3 less bulky in volume, and so as to balance in weight and/or aesthetically, the bracelet 1 from the invention, on either side. Thus, the bracelet 1 can find a better balance when kept around a wrist.

According to this embodiment, the power supply connector(s) feeding the electronic components of the frame, can be routed along the band 2, for example, inside the band 2 so as to be hidden from outside.

According to another embodiment, the power supply 4 is arranged on the upper part of the bracelet 1. For example, the frame 3 can comprise the power supply 4. According to another embodiment, the power supply source can be comprised in another frame placed right next or juxtaposed to the frame 3 at the upper part.

According to one embodiment, the power supply is a rechargeable battery. The battery can then be removable, and thus has to be removed from the bracelet 1 to be recharged. Another solution consists of placing the bracelet 1 on a base comprising a power supply for recharging the battery which stays in position inside the bracelet. According to another mode, the power supply source is an replaceable battery.

Frame

According to one embodiment, the frame 3 comprises an infra-red emitter 30. The emitter 30 then emits a light beam 31 forming a light sheet. Advantageously, the emitter 30 is arranged in the lower part of the frame, and can be a linear emitter. The lower part of the frame 3 is defined as the part closest to the skin of the wrist or of the forearm or of the hand of the person wearing the bracelet 1. According to other modes of use and according to the different ways of wearing the bracelet from the invention, the display can be shown on the front face or on the rear face of the forearm. In a similar manner, images can be projected on the inside or on the outside of the hand. One advantage is that of producing a substantially flat beam as close as possible to the skin, and substantially parallel to the surface of the wrist or of the forearm.

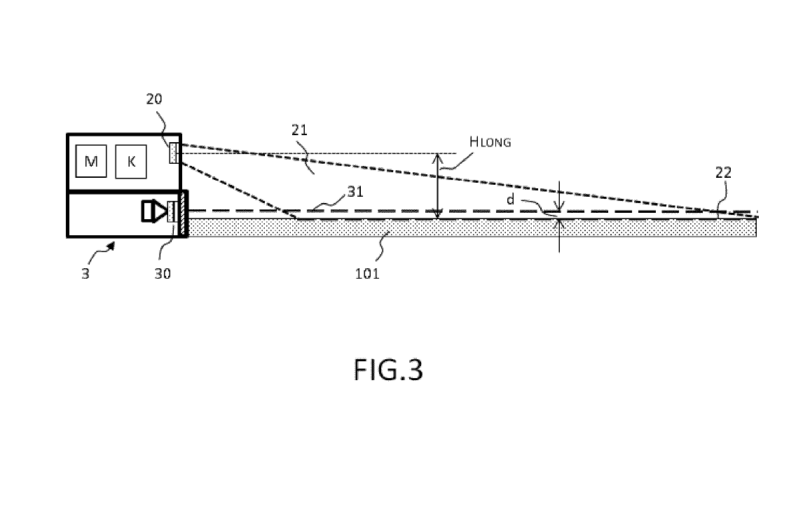

FIG. 3 shows a section view where the beam 31 is parallel to the forearm surface 101, and located at the height d.

According to one embodiment, the frame 3 comprises a projector 20 making it possible to project an image along an axis intercepting the wrist of the forearm of a person wearing the bracelet 1. FIG. 3 represents in a cross-section view, a portion of the projection cone 21 intercepting the forearm 101 to form an image 22. The projector is arranged in the frame at a height, called HLONG, from the surface of the forearm 101.

According to one embodiment, the frame 3 comprises a first detector 10 for detecting, in the infra-red range, the modifications of colours relating to the interactions of the beam emitted by the emitter 30.

According to one embodiment, the frame 3 comprises a second detector 11 for detecting the images emitted in the range of visible frequencies for the real-time adjustment of the image size and/or for the real-time calculation of the distortion factors to apply to the projected image.

According to one embodiment, the frame 3 comprises means of calculation, designated by M on FIG. 3, such as a computer which can be a microprocessor, a micro-controller or an electronic chip. The means of calculation can comprise, according to the embodiment chosen, one or a plurality of computers carrying out different image processing functions. Amongst these functions, there are the generation of images and the calculations of factors for distorting and/or for correcting images. Furthermore, the computer makes it possible to perform calculations of interaction points and servo-control points for generating new images depending upon the controls detected. The computer is thus able to generate images to be projected depending upon the interactions detected, and all of the other functions required for embodying the invention.

According to one embodiment, the frame 3 comprises one or a plurality of memories, designated by M in FIG. 3, to record temporary calculated values or to store interaction information data such as positions of interaction points or to store data making it possible to generate images or any other data required for embodying the invention.

According to one embodiment, the frame 3 comprises an accelerometer and a gyroscope for measuring the movements of a wrist and/or of the forearm of a person wearing the bracelet 1. The movements detected can be detected by comparing acceleration values with reference to known and recorded values which correspond to actions to be carried out. As an example, turning on the bracelet can be done by turning the wrist twice in a row along the forearm axis. The acceleration values measured over a given period of time, make it possible to determine which action has to be undertaken depending upon the movement sequence detected.

According to another example, a wakening action can be set to activate the bracelet 1 when a threshold of acceleration in rotation against the forearm has been crossed.

Other actions can be indicated according to acceleration values measured along the three axes of a Cartesian frame of reference to generate specific actions such as for example: activating a detector or a projector, turning off a detector or a projector, generating an image or modifying the generated image, activating a new image from a first image depending upon a browsing history.

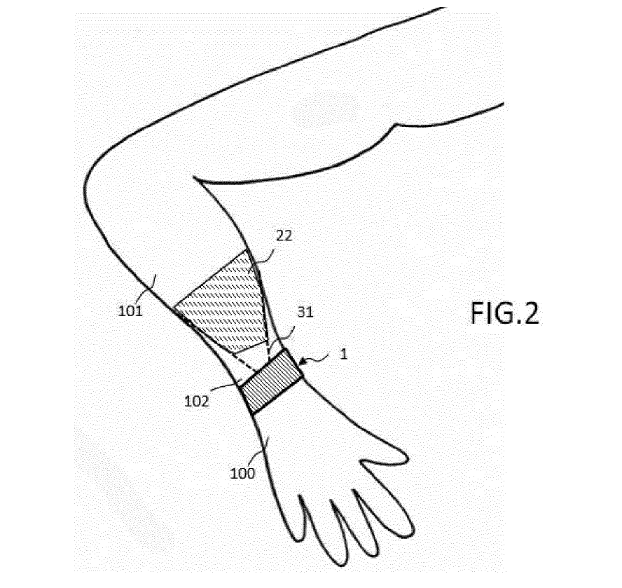

FIG. 2 shows a bracelet 1 of the invention positioned on a portion of the arm located in-between the forearm 101 and the hand 100. This junction zone is called the wrist 102. This zone is advantageously intended for wearing the bracelet 1 of the invention. The bracelet 1 is shown projecting an image 22 on the forearm 101 of a person. The infra-red light beam 31 is also shown overlapping the image displayed on the forearm 101.

According to another embodiment, the display of the image 22 and the generation of the beam 31 can carried out on the hand. To this end, one mode allows, for example, the bracelet 1 to be turned over and the display to be inverted so as to activate the projection direction of the image 22 towards the hand, while benefiting from an image displayed along the reading direction. According to another embodiment, the bracelet is configured for a display towards the hand. However, this mode of display does not provide the entire projection surface of the forearm 101. The fingers and notably the carpal bones limit the display zone and cause a distortion of the displayed image. Moreover, the movements of the hand 100 are often more sudden and more sporadic than those of the forearm 101, and, for this reason, the image stabiliser has to be more reactive and has to be configured so as to take into account the movements of the hand.

In the following of the description, the display mode along the forearm 101 is described, and corresponds to a preferred mode of the invention.

Detection of Interaction Points

The beam 31 is preferentially emitted in a non-visible frequency band so as not to alter the image 22 projected by the projector 20. According to one embodiment, the light beam is emitted by a linear emitter generating a substantially flat beam in an infra-red frequency range. The beam is emitted along a plane substantially parallel to the skin surface between 1 mm and 1 cm from the skin surface. A distance between 1 mm and a few millimetres makes it possible to obtain a good detection efficiency over the projection zone, limiting the false detections errors.

In one embodiment, a management module for the power of the emitted beam can be integrated into the frame. A control accessible to the user, either digital or by a discrete means allows the user to adjust the beam power. This control makes it possible used to set, for example, a night mode or a day mode. By default, the power is configured to provide good detection both at night and during the day.

The detector 10 makes it possible to acquire, in a given frequency range, at least a trace 32 formed by the interception of the beam by a body. In a nominal use of the bracelet 1, the body intercepting the beam is generally the finger of a user, which is positioned over a zone of the displayed image. An advantage of the bracelet 1 of the invention is to reproduce an interactivity comparable to that of smart phones or tablets which comprise a touch-screen, but without the use and the bulk of such a screen. Another body can be used, such as, for example, a stylus. When the body is a finger, one advantage of the invention is that the interaction can be detected even when using a glove, which is not possible with a touch-screen.

When a body intercepts the light beam 31 in at least one point, the detector 10 acquires a light variation which may result in the presence of a white spot when the beam is an infra-red beam. The detector 10 thus makes it possible to generate an image containing the trace 32 having, in the acquired image, coordinates corresponding to the interaction point the user wants to initiate by the action of his finger. We recall that the user does not see the infra-red beam 31, but only the projected image 22. Thus, the bracelet provides control interactivity transparent for the user. The interaction point thus corresponds to the image zone the user wants to activate. Activation can correspond to the desire of browsing on another page by activating a link or can correspond to a choice amongst a list of choices or of an option which is displayed and has to be validated. Other examples of activations can be considered according to the bracelet 1 of the invention.

One advantage of the arrangement of the detector 10 which is positioned higher than the beam emitter 30, on the bracelet 1 frame opposite the wrist surface, is that of obtaining a good image taking reflecting traces related to the interception of the beam by a body. There are other systems for estimating the depth position of an interaction, such as, for example, a “radar”-type operation, but these latter solutions are approximate and do not make it possible to discern many points over the interaction zone. These latter devices generate many false detections due to the inaccuracy in estimating the distance from the body to the detector. One advantage of the bracelet of the invention is that of proposing a detector arrangement providing a detection perspective for the displayed image. This configuration improves the detection of an interaction point, and the accuracy in determining the coordinates of the center of the interaction point.

According to the embodiments of the invention, the interaction point can be determined in the frame of reference linked to the projected image or in the frame of reference of the acquired and transformed image. The two variants are substantially equivalent and provide comparable results. Both methods comprise their own advantages which can be chosen according to the design considered. As an example, when position calculations are performed in the frame of reference of the image displayed on the forearm, the calculations linked to the transformation matrices of the detected spot, are simplified. On the other hand, when position calculations are performed in the frame of reference of the acquired and transformed image, a gain of accuracy can be obtained in the determination of the center of the spot detected and in the determination of the activated zone of the image.

The bracelet 1 of the invention thus makes possible the analysis of at least one position of one interaction point of a user, so as to determine which zone of the image will be activated. Indeed, the image can contain interaction zones. A software cut of the image makes it possible to divide the image into different interaction zones. The invention then makes it possible to compare the position of the interaction point of the beam with reference points, and to identify to which interaction zone of the image the point corresponds.

To this end, the bracelet 1 of the invention makes it possible to transform the image acquired by the detector 10 in a known frame of reference of a non-distorted image. In this frame of reference, the image projected before applying distortion factors, or the image acquired after the distortion factors are applied, is called the original image.

Different distortions can be applied to the acquired image to switch it to a format related to the original image. The distortions applied to the image when being projected, enable the user to view the image as if it was displayed, while preserving the proportions of an original image. Inversely, the distortions applied when acquiring images make it possible to take into account the deviations relating to the fact that the detection plane is not parallel to the plane of the image and of the perspective effects.

A first transformation can be applied to compensate for the lateral shift DLAT of the detector 10 with respect to the projection central axis.

A second transformation can be applied to compensate for the perspective effects of the image projected in depth, and to apply an change aiming at restoring the image acquired in a 2D plane. The perspective effects can take into account the height between the detector 10 and the plane of the projected image 22, substantially parallel to the plane forming the forearm 101. The acquired image can then be transformed to compensate for this deviation. Furthermore, the lateral perspective effects can be taken into account through the transformation factors, as well as the edge effects namely comprising the part of the image closest to the bracelet, and the furthest away part.

A third transformation can be applied to compensate for the surface effects relating to the anatomy of the forearm or of the hand, which would be taken into account in the projection of the projected image 22.

The trace 32 detected in the acquired image can be transformed so as to obtain a trace 32′ in the frame of reference of an image non-distorted by the projection of the latter on the forearm. The non-distorted image is called original image as previously stated.

The trace 32′ in the original image contains one or a plurality of pixels in the frame of reference of the original image.

A step of determining the center 33 of the trace 32′, or of a barycenter, can be initiated so as to determine the most likely image interaction point a user wanted to activate. The point thus calculated, called the “interaction center” 33, can be a pixel of the image.

A step of comparison between the position of the interaction center 33 and the original image makes it possible to determine the action to be initiated by the computer.

According to one embodiment variant, the interaction center can be calculated on the acquired image not yet corrected by the transformation factors. In this case, the transform of the interaction center of the trace of the acquired image makes it possible to determine the position of the interaction center of the trace of the original image.

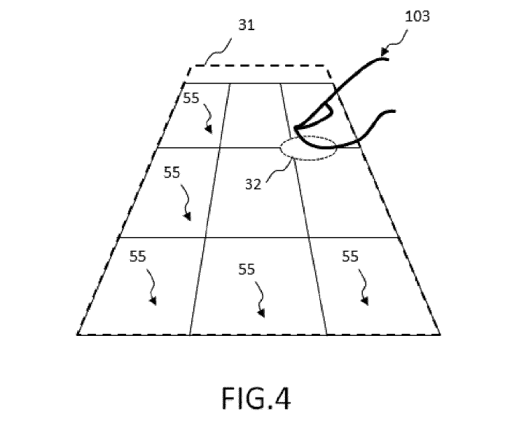

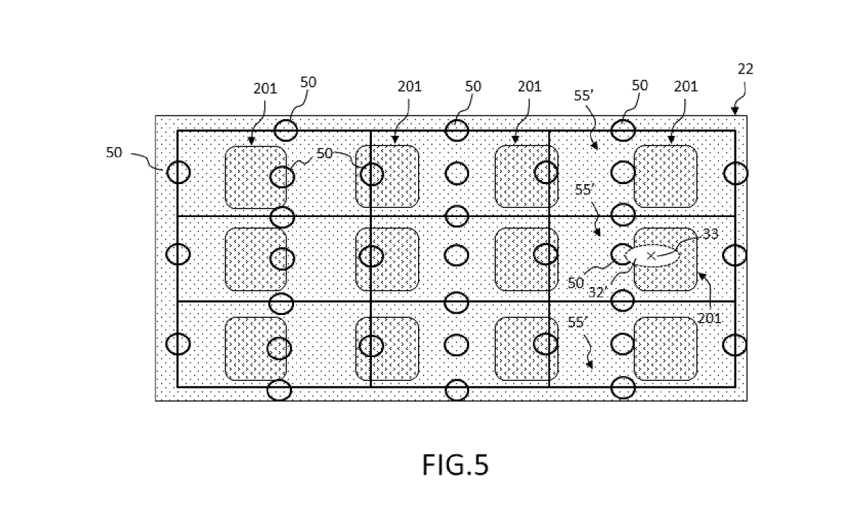

According to one embodiment, the position of the interaction center 33 is compared with a matrix of points delimiting the zones 55 or 55′ depending on whether the acquired image or the original image obtained by the transformation of the acquired image is considered. Such zones 55 are shown in a perspective view in FIG. 4, overlapped with the beam 31, and are shown in the original image in FIG. 5.

The delimiting points 50 are defined so as to delimit the interaction zones 55′.

FIG. 5 shows the zones 55′ in a frame of reference related to the original image, and the delimiting points 50. To this end, the image is delimited in the zone 55 by a gridding in the frame of reference related to the original image. According to one embodiment, the gridding has identical rectangular surfaces. But any other gridding is compatible with the bracelet 1 of the invention. According to other variants of embodiment, the zones 55′ can be defined forming squares, rhombuses or circles. The position of the interaction center 33 is thus compared to the position of the delimiting points 50 or to the limits of the zones 55′. An algorithm making it possible to calculate the distances from the interaction center 33 to the closest delimiting points 50 makes it possible to estimate the zone 55′ which is activated by the user. When a trace “overlaps” two zones 55′, the bracelet is configured to determine the proportion of the spot in each of these zones. According to one embodiment, the zone 55′ containing the largest number of pixels of the trace 32′ is determined as the active zone.

Advantageously, in this embodiment, the image display contains zones which can be activated, the activation of which is determined depending upon the calculation of the position of the interaction center 33 in the image.

FIG. 5 shows the icons 201 of the original image. In this example, the calculation of the trace 32′ or of the center 33 thereof, in the frame of reference of the original image can be moved closer:
either directly to the position of the closest icon 201, and thus having the closest pixels or pixels in common with the trace 32′;
or to a zone comprising this graphical icon, the identification of the zone thus leading to the identification of the icon contained in this zone.

Thus, the use of these zones remains optional. When the position of the interaction center is directly compared with zones of interest of the image, it is possible to determine which action has to be initiated. The use of zones makes it possible to make the detection of interaction points more robust by performing a simple comparison with the zone concerned corresponding to the determined interaction point. The comparison makes it possible to end up with an action related to the activation of said determined zone.

Other actions combining different interaction points 33 can be detected, according to the same principle, by the bracelet 1 of the invention.

As an example, two interaction points 33 can be detected. When these two interaction points 33 make a relative movement one towards the other or one away from the other, this can correspond to an enlargement or to a reduction of the image to be displayed, or of a zone of the image. In this embodiment, the detection of movements comprises the detection of a set of interaction points. Instantaneous vectors can be derived. When two interaction points are in movement, it is possible to compare the directions of the instantaneous vectors and to generate an activation instruction for a function. To this end, the computer makes it possible, for example, to enlarge a portion of an image or the whole image according to the position of the determined centers of interaction.

Image Projection

FIG. 3 shows the projector 20 projecting an image on the forearm 101. The projection makes it possible to distort the original image by applying distortion factors to the image. These distortion factors take into account perspective effects. These perspective effects can notably take into account the field depth, that is to say the delimiting of the image to display on the furthest away part of the bracelet 1, taking into account the projector height with respect to the projection plane located on the skin of the forearm 101. Furthermore, the image transformation factors which compensate for the perspective effects, take into account the lateral distortion of the image, that is to say the points of the image farthest, laterally, from the main optical axis.

Distortions potentially take into account the anatomy of the surface of the forearm or of the hand of a user, according to the morphology thereof. As an example, a mean or standard morphology is applied to an image projected by the bracelet 1, and can be adjusted according to the different user morphologies. Corrective factors of transformation factors can be applied to modify the transformations applied to the projected image.

One objective of the image transformation factors is that of displaying an image on the forearm of a user, which would be close to an original image for the user. It is then necessary to compensate for certain natural distortions related to the image projection mode, and to the projector itself.

The computer of the bracelet of the invention can be used to perform calculations for image processing, notably the application of distortion and/or corrective factors. Another computer can be used to generate images. According to one embodiment, the same computer generates the images and transforms the images from corrective or distortion factors.

The projector can be a laser projector such as a colour laser pico-projector.

According to one embodiment, the image projector comprises a blue laser, a red laser and a green laser, and a set of micro-mirrors rotating so as to produce at each projection point, a point the colour of which is generated by a combination of the three lasers oriented by the mirrors.

According to one embodiment, the image projector can be for this purpose, an LCOS-type projector, meaning “Liquid Crystal On Silicon”. This technology is used to mix one source of light with another source of light. The source of light can be generated by one or a plurality of laser(s) or by one or a plurality of diode(s). A liquid crystal screen can be directly mounted on an in-built component. A prism can be also used.

According to one embodiment, called high-definition, the image projector emits an image having a resolution of 1920×2080.

### Second Detector 11

According to one embodiment, the bracelet 1 comprises a second detector 11 making it possible to acquire colour images. The second detector makes it possible to apply corrective factors to the transformations to be applied to the projected image. In particular, an analysis of the contours of the projected image makes it possible to readjust the transformation factors to be applied to the projected image. To this end, corrective factors are applied to the transformation factors to take into account the actual display detected on the forearm.

The second detector 11 makes it possible to improve, in particular, the function of image stabiliser. The contours of the displayed image 22 can be regularly compared to a control image having expected nominal dimensions, the characteristics of which are recorded in a memory M. This real-time comparison between the dimensions of the displayed image and of the recorded image makes it possible to generate corrective factors. The corrective factors can thus be generated depending upon the deviations calculated by a computer between two image dimensions.

These corrective factors make it possible to compensate for the movements of a wrist, a hand or a forearm. Furthermore, these corrective factors make it also possible to compensate for an inclination of the frame when the bracelet has play around the wrist. The corrective factors make it possible to provide the user with a function of image stabiliser.

Furthermore, the dimensions of the images acquired by the two detectors 10 and 11 can also be compared to guarantee the consistency of image stabilisation and the detection of the interactive zone of the image.

Finally, the second detector 11 makes it also possible to perform a second calculation for detecting an interaction center or an interaction zone. The positions obtained by the two detectors coupled to one or a plurality of computers can be correlated to reduce the rate of false detections.

An image calibration can be defined by means of a bracelet. The image calibration aims at projecting a control image and at applying transformation factors according to what a user wants. To this end, the bracelet of the invention comprises an interface with buttons or switches making it possible to apply modifications of the corrective or distortion factors for images. Thus, the calibration makes it possible to ensure that the image is conveniently displayed for a user, that is to say in a substantially rectangular format compensating for the perspective effects. The calibration makes it possible to adapt the image format to a given user morphology. One advantage is that of determining a display format, and then to proceed to corrections so as to compensate for the movements when using the bracelet. Another advantage is that of making possible the calibration phase at any moment, making it thus possible to compensate for anatomy deviations or changes. It is also possible to customise the display according to the users, the bracelet can then be pre-set according to different calibrations, and thus can be used by different persons.

According to one embodiment, the bracelet 1 comprises a fabric which can be unfolded over the forearm to form a screen. The fabric can be integrated to the band 2 or to the frame 3 or to the compartment 4 which contains the battery. The fabric can be held at the end thereof by an elastic or by a second bracelet which can be attached to the arm to tension said fabric.

According to one variant of embodiment, the bracelet 1 extends longitudinally, for example by means of concentric rings which are superimposed. A locking and unlocking system is used to switch to an extended mode for the bracelet 1, and to lock it. The rings are then designed to hold, for example, due to diameters cooperating at the ends between two superimposed rings. An elongation device for the bracelet 1 is then similar to an unfolding device such as a “fishing rod”. In a similar manner, the rings can be unclosed ring portions which cover a part of the forearm. One advantage is that of forming a screen superimposed on the forearm skin. This embodiment makes it possible, in particular, to ignore the topology of the surface of the forearm of a person, hair and different forearm thicknesses.

Pairing

According to one embodiment, the bracelet of the invention can be paired with a device connected to a mobile or terrestrial network such as a Smartphone, a tablet or a computer. A wireless connection is advantageously used to pair the devices with each other. The wireless connection can be established using a Bluetooth or Wifi protocol or any other protocol making it possible to establish such a connection. The bracelet of the invention comprises, for this purpose, a radio component or a network component making it possible to establish such a connection. The computer present in the bracelet of the invention is configured to process the data received from the device, and process the images for projecting them.

According to one embodiment, the image projected by the bracelet of the invention is an image generated by the device and transmitted by the wireless connection to the bracelet.

According to one embodiment, when an interaction on the image displayed by the bracelet is detected, the bracelet processes the interaction independently from the device, for example by providing an interactive menu, and by validating a user choice or by actuating a button making it possible to generate a second image. To this end, the bracelet is able, for example to directly generate a request to a network device via an access to a network independently from the device. According to another case, the bracelet comprises a memory where the data to be displayed are saved. Other interactions can be considered according to variants of embodiment which can be combined with each other.

According to another embodiment, the bracelet of the invention is configured to generate a request to the device for processing the interaction detected on the displayed image. The bracelet is thus used as a display alternative to a device such as a Smartphone. If, for example, a button displayed on the forearm is activated, the request sent to the device makes it possible to return an action or an image to the bracelet. The latter will then be able to project the result of the interaction.

Network Connection

According to one embodiment, the bracelet comprises a network component making it possible to connect to a network. The connection can be established, for example, via a wireless connection such as a Wifi or a Bluetooth connection or any other protocol making it possible to establish a wireless connection. As an example, the bracelet can be configured to connect to an internet box via a Wifi network or a 3G or 4G mobile network. The bracelet is then able to generate requests via the box through the network to be interfaced with a server. Thus, the bracelet is a connected bracelet which makes it possible to display, for example, a digital content coming from the internet network. In this case, a video from a video platform can be displayed on the forearm due to the reception of video frames and of their processing by the computer of the bracelet and of the image projector.

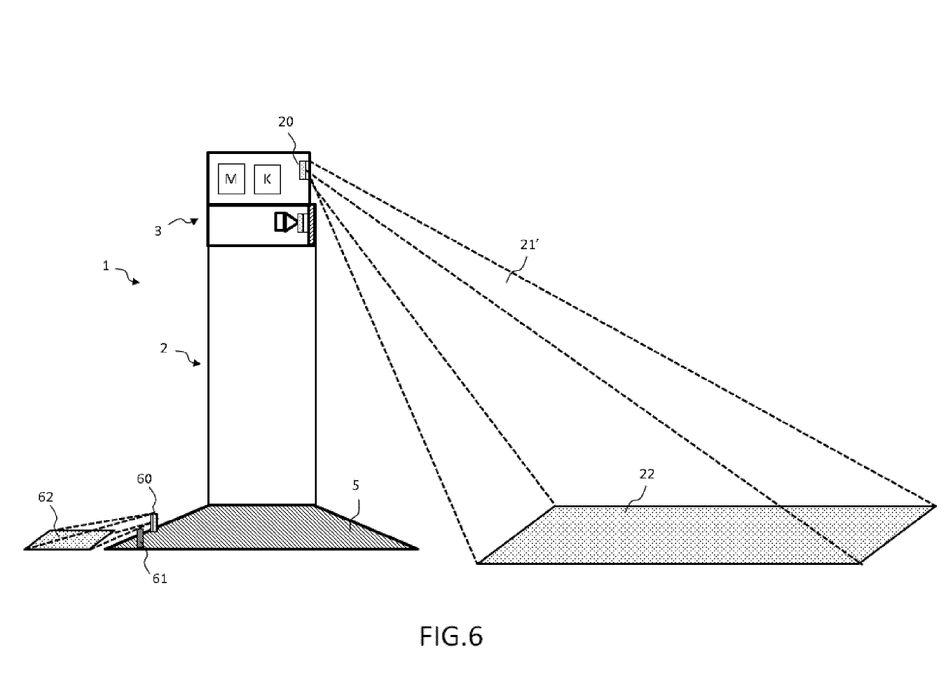

FIG. 6 shows another embodiment of the invention wherein the bracelet 1 can be affixed and/or attached to the support 5 forming a holding base.

In this embodiment, a second display mode can be initiated by a user. The image obtained can be, in this case, of larger dimensions, in particular obtained by obtaining a larger interception surface between the cone 21′ and the display surface.

It is to be noted that the base can comprise its own power supply source to feed the bracelet 1 or to recharge the battery 4 of the bracelet 1.

According to one embodiment, the base comprises an emitter 61 of an infra-red beam, and the detector 60 making it possible to acquire the image 62 and to detect interaction points of a finger in an interactivity zone. Advantageously, the interactivity zone is projected onto the other side of the bracelet 1 opposite the projection of the image 22, as shown in FIG. 5.

The user can thus use his finger as a mouse to move the cursor displayed over the image or to activate a zone of the image 22. Thus, to interact with the image, the user does not need to interfere with the image projected with his hand. The computer K makes it possible to take into account the movements or the actions realized by one finger interacting over the interactivity zone 62 to generate actions on the image 22 to be displayed. According to the invention, the following actions can be found amongst the actions the computer can initiate: a modification of the image, a validation of a choice, for example, to generate a request to a server, the generation of a new image, the activation of a menu or of a button, etc.

This embodiment is especially advantageous for a projection onto a wall, a train or a plane table. Furthermore, it makes it possible to stabilise the image and to provide improved viewing comfort.

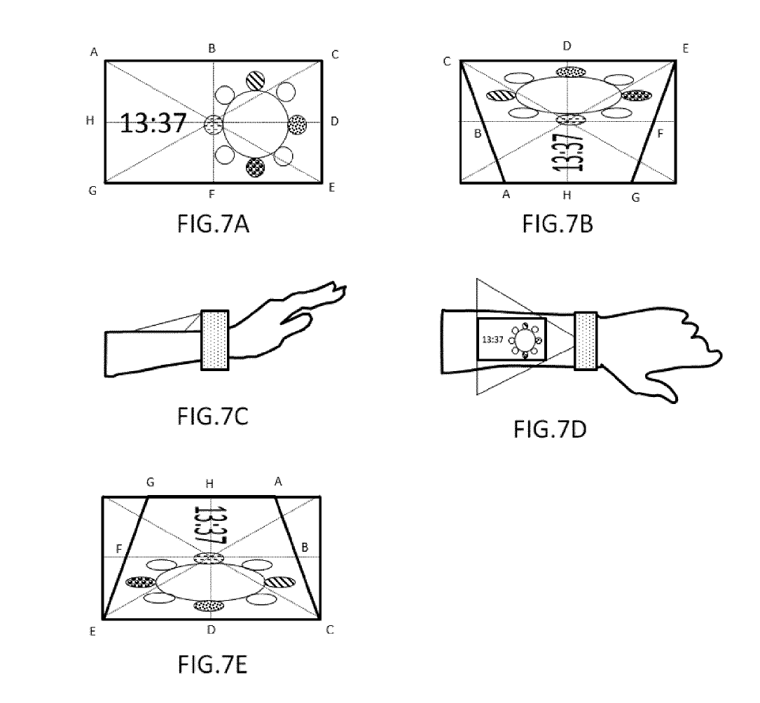

FIGS. 7A to 7E show an example of image correction and of the calculation of corrective factors applied to the projected images.

FIG. 7A shows an image to be projected by the computer. The image can be encoded in a compression format such as jpeg or any other format. In this example, the image indicates a time “13:37”, and a symbology representing circles. The image is shown undistorted in a rectangle with reference marks A, B, C, D, E, F, G, H.

The computer applies transformation factors to the image so as to project a distorted image. This distorted image aims at compensating for the distortion related to the geometry of the optical system so that a user observes a non-distorted image displayed on the forearm thereof.

To this end, the computer performs a first 90° rotation anti-clockwise of the image. A trapezoidal distortion is then applied. The distortion factors applied correspond to a calibration at the first use. During this calibration, a reference image has been recorded in a bracelet memory.

FIG. 7B shows an image transformed by the computer of the bracelet, with the distortion factors recorded in a memory of the bracelet following the calibration at the first use.

FIGS. 7C and 7D schematically show the projection of the image of the bracelet projector on a wrist, in a cross-section view and in a top view. The transformations of the projected image enable to compensate for:
effects related to the relatively small projection angle between the arm axis and the projection axis, and;
effects related to the projection cone inducing a widening of the image projected along the arm.

FIG. 7E shows the image acquired by a camera of the bracelet. This image is compared to a reference image stored in a memory of the bracelet. The reference image is a calibration pattern of which certain characteristic points can be identified to measure, for example, the distortions relating to the topology of the display surface, that is to say the arm morphology.

When using the bracelet, that is to say when displaying and acquiring images, a real-time corrective mechanism is applied. This corrective mechanism aims at taking into account not only the distortions relating the morphology of the arm and/or of the wrist, but also the distortions relating to the movements of the arm and the distortions relating to the context of use. Corrective factors are thus calculated in real-time, to adapt the distortion factors in real-time.

The acquired image is corrected according to the reference image in real-time. A display pilot can be installed to undertake the functions of comparing images and of applying corrected or not corrected transformation factors.

The distortions and the corrections of the distortions measured in real-time make it possible to project an image compensating for these distortions so that the user can observe images as little dynamically distorted as possible.

To carry out the comparisons between the acquired images and the reference image, according to one example of embodiment, the lengths A-C, C-E, E-G and G-A are compared between the two images. When these measurements do not coincide, within a tolerance, between the lengths of the reference image and of the acquired image, a corrective factor is calculated for each value of the measured lengths of the image, to correct the new transformation factors. The new transformation factors are obtained from transformation factors calculated during the calibration or the first use, and from corrective factors dynamically calculated during the acquisition of projected images.

Thus, the distortions of the image to be projected take into account the display of the current image. Thus, the projected image is continuously and automatically transformed so that the user observes a non-distorted image.

According to one alternative of embodiment, a “control image” is emitted in the flow of images projected by the projector, for the user. The control image is an image generated by the processor, and used to calculate corrective factors. However, it has no value for the observer. One interest is to benefit from an image designed for the calibration, that is to say an image generated with a contrast making it possible to cut out the image edges irrespective of the conditions of ambient luminosity or intrinsic luminosity of the projected image. As an example, the control image can be a substantially opaque or dark or black image. Indeed, the control image is generated so that it provides a contrast, delimiting the creepage distances of the trapezium, and even the proximal edge of the projected image opposite the detector, and the farthest edge from the detector, the two edges being secant with the creepage distances of the more or less distorted trapezium of the projected image.

One advantage is that the control image is inserted into a continuous flow of images projected at a given frequency so that is invisible for the eye of a user. As an example, if the refreshing frequency of the projected images is comprised between 13 and 30 images per second, the emission of a control image in a one-second window is almost imperceptible for the observer. The control image can be emitted at a known moment in the flow of emitted images, for example, it can be the last image of a sequence of 24 images emitted per second. Such an image can be regularly emitted at predefined times with respect to the emitted flow of images. For example, the control image can be emitted at regular times, as, for example, every 2 s. Advantageously, the bracelet comprises a clock making it possible to timestamp the generation of control images to be transmitted, and to insert them in the flow of projected images.

One advantage of using a control image is that it makes it possible to carry out a dynamic calibration of the transformation factors through the calculation of the distorted geometrical shapes of this image displayed on the forearm. For the corrective factors of the transformation factors to be calculated in an optimised manner, the control image makes it possible to reduce the interpretation errors of the geometrical shapes of the images captured.

According to one embodiment, a distortion can be obtained by placing a 3D point of view from an OpenGL library. Through a calculation, the computer virtually moves the point of view of a value corresponding to the shift observed during the measurement.

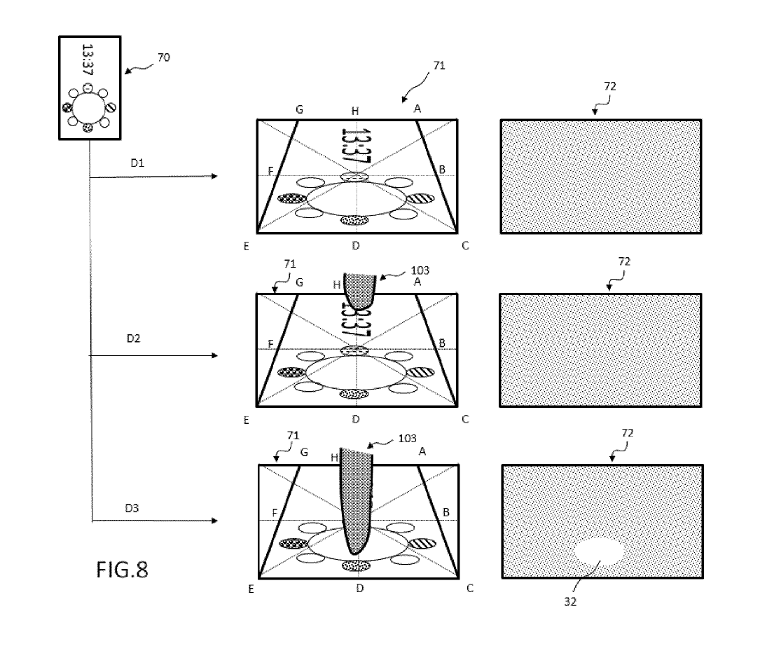

FIG. 8 represents three cases of detection of two images by two different detectors of the bracelet. The first image 71 is detected by a detector of the bracelet, such as a colour camera. The second image 72 is detected by an infra-red detector of the bracelet. The detectors can be, for example, cameras.

The image 70 represents the image of FIG. 7A calculated by the computer without distortion. This is the image to which the computer will apply corrective factors to compensate for the display effects so that the user observes a non-distorted image.

The first detection D1 allows the two detectors to acquire the first image 71, and, respectively, the second image 72. In this first detection, no interaction is detected. Indeed, the colorimetric image 71 acquired by the colour detector is compared with the image to be displayed, within the transformation factors. No zone of image had undergone any colour modification. Moreover, the image 72 does not comprise any trace. Therefore, the infra-red detector does not detect any variation of light. It has to be noted that, for an infra-red detector, a finger trace leaves a white trace on the acquired image.

The computer derives, from comparison operations between the displayed images and the acquired images, that no interaction took place.

FIG. 8 illustrates a second detection D2 carried out soon after the first detection D1. The finger 103 of a user enters into the field of the colorimetric image 71, but does not intercept the infra-red beam, that is to say the infra-red beam is superimposed on the image on a portion of the arm.

The computer in the bracelet continuously carries out comparison operations between the displayed images and the images detected by the two detectors. Via the projected and acquired images 71 analysis, the computer detects a variation of colour in a portion of the image. Automatically, the computer carries out a correlation operation with the result of the comparison between the projected and the acquired infra-red images. But, in this case, no modification of the infra-red image 72 has been detected by the computer. In the case of the detection D2, the infra-red image 72 has not been modified, since the finger 103 did not intercept the infra-red beam. Therefore, the computer does not generate any detection indicator for an interaction point on a portion of displayed image. Indeed, the detection algorithm makes it possible to differentiate a case of movement in the image without interaction with the image, from a case where a zone of interaction with the image is initiated by the user.

A third detection D3 illustrates the case where the computer detects an interaction point. The finger 103 draws a shape on the captured colorimetric image 71. Moreover, the analysis of the image 72 makes it possible to detect a spot 32 corresponding to the zone where the finger intercepts the infra-red beam. When the computer detects a variation of the colorimetric image corresponding to the detection of a spot on the image acquired by the infra-red detector, then the latter generates a detection indicator of an interaction zone.

In this case, according to one embodiment, the center of the interaction zone can be calculated, and the interactive action corresponding to the zone touched by the finger can be generated according to the invention. This can lead, for example, to the display of another image on the arm of the user.

According to an example of embodiment, the detection can be carried out in real-time in less than 300 ms, through the analysis carried out by the computer on the two images acquired by each detector. The comparison operations on images are continuously carried out by the computer so as to automatically generate interactive actions depending upon the detection zone of the interaction point.

1. An electronic bracelet for displaying an interactive digital content designed to be projected on a zone of an arm, comprising:
an emitter of configured to emit a light beam in a non-visible frequency band forming a light sheet designed to cover a first zone of an arm;
a projector configured to project an image over a second zone, the first zone substantially overlapping with the second zone;
a first detector configured to capture an image of the second zone;
a computer configured to determine at least one position of at least one interaction point of the light beam by analysing a trace of the image acquired by the first detector.

2. A bracelet according to claim 1, comprising a band configured to be held around a wrist, a power supply source and a frame arranged and kept on an upper part of the bracelet, said frame comprising the emitter, the projector the first detector and the computer.

3. A bracelet according to claim 1, comprising:
a component configured to apply mathematical factors of distortion to the projected image, so as to compensate for:
a surface distortion relating to the forearm anatomy, and/or:
a distortion of perspective taking into account:
lateral distortions of the projected image;
distortions of field depth of the projected image;

4. A bracelet according to claim 1, wherein the emitter of the light beam is an infra-red emitter.

5. A bracelet according to claim 1, wherein the emitter is a linear emitter projecting configured to project a substantially flat light beam.

6. A bracelet according to claim 2, wherein the emitter is arranged on the frame in a position located between the projector and the band of the bracelet.

7. A bracelet according to claim 1, wherein the first detector has a sensitivity range for detecting a trace caused by the interception of the light beam with a body.

8. A bracelet according to claim 7, wherein the first detector is an infra-red detector capturing an image in which the light beam forms an image, of which the longitudinal dimensions along the projection direction, are identifiable.

9. A bracelet according to claim 1, wherein the position of at least one interaction point is calculated from:
a transformation of the image and of the trace, both acquired into an original image comprising an image of the trace from transformation factors;
a geometrical construction of an interaction point of at least one trace or image of the trace.

10. A bracelet according to claim 9, wherein the computer is configured to compare the position of the interaction point with a matrix of points delimiting interaction zones in a frame of reference linked to the original image, the computer inferring an interaction probability with an interaction zone.

11. A bracelet according to claim 1, further comprising a detector configured to acquire calorimetric images of the second zone.

12. A bracelet according to claim 11, comprising an image stabiliser, said image stabiliser configured compare the images acquired by the second detector with the dimensions of a reference image, and to generate corrective factors to be applied to the image distortion factors depending upon the comparison between said images.

13. A bracelet according to claim 11, wherein the image stabiliser is configured to compare the longitudinal dimensions of the second zone of the images acquired by the first detector with the dimensions of at least one image acquired by the second detector to generate corrective factors to be applied to the transformation factors.

14. A bracelet according to claim 1 wherein the computer generates is configured to generate a control image, and wherein the projector is configured to regularly project said control image in the flow of projected images, said control image being acquired by at least one detector of the bracelet so as to compare characteristic dimensions of the acquired image with a reference image, in order to calculate image corrective factors

15. A bracelet according to claim 12, wherein the reference image is calculated during a calibration or first use operation, the reference image being obtained by applying transformation factors to a projected image to obtain a displayed image with expected dimensions, the application of transformation factors during said operation being carried out from an interface of the bracelet.

16. A bracelet according to claim 11, wherein the second detector is configured to perform a second calculation of an interaction point via the analysis of a trace intercepting the image, said trace being obtained via an analysis of the modification of pixel colour in a portion of the acquired image.

17. A bracelet according to claim 16, wherein a computer is configured to correlate the position of an interaction point obtained from an image acquired by the first detector and the position of an interaction point obtained from an image acquired by the second detector, the correlation of positions making it possible to generate a new position of an interaction point.

18. A bracelet according to claim 1, wherein the image projector is a colour pico-projector.

19. A bracelet according to claim 18, wherein the image projector comprises a blue laser, a red laser and a green laser, and a set of micro-mirrors rotating so as to produce at each projection point, a point the colour of which is generated by a combination of the three lasers oriented by the mirrors.

20. A bracelet according to claim 1, comprising an accelerometer and a gyroscope for activating functions generating a modification or a change of the image projected by the projector.

21. A projection device comprising a bracelet according to claim 1, comprising a base comprising a system to hold the bracelet, wherein the computer of the bracelet, comprising a second projection mode, comprises second image distortion factors making it possible to project images on a second projection plane, the second projection plane being merged with the support plane of the base.

22. The projection device according to claim 21, wherein the base comprises an emitter of a substantially flat infra-red beam and a detector, both placed on a side opposite a support side facing the image projection of the projector, said detector configured to record images containing at least one interaction trace when the beam is intercepted by a body, the computer configured to generate interaction instructions modifying the image projected according to a detected interaction zone.
